(19) United States
(12) Patent Application Publication
(10) Pub. No.: US 2003/0127879 A1
(43) Pub. Date: Jul. 10, 2003

(54) Articulated license plate mount for a drop-gate

(76) Inventor: Ronald Joseph Smith, Sterling Heights, MI (US)

Correspondence Address: LAURA C. HARGITT, General Motors Corporation, Legal Staff, Mail Code 482-C23-B21, P.O. Box 300, Detroit, MI, 48265-3000, US

(21) Appl. No.: 10/036,226

(22) Filed: Jan. 4, 2002

(51) Int. Cl. B62D 33/03

(52) U.S. Cl. 296/57.1; 40/209

(57) ABSTRACT

An articulated license plate mount for locating a license plate at the drop-gate of a vehicle, wherein the license plate will be visible to onlookers at all times whether the drop-gate be at, or between, its upright and prone positions. A gate bracket is connected to a drop-gate, a license plate is connected to a license bracket, and a pivot connection pivotally connects the license bracket to the gate bracket. As the drop-gate is rotated from the upright to the prone position, the license plate rotates on the pivot connection so as to remain vertically oriented and visible to onlookers.

### TECHNICAL FIELD

The present invention relates to license plate mounts for motor vehicles and trailers, and more particularly to an articulated license plate mount for a drop-gate.

### BACKGROUND OF THE INVENTION

The departments of motor vehicles of the various states require a license plate be displayed at the rear of vehicles using public highways. This requirement applies to motor vehicles, such as cars and trucks, whether private or commercial, as well as to trailers being towed thereby. Accordingly, original equipment manufacturers (OEM) of motor vehicles and trailers provide a license plate mount at the rear of the vehicle. Such license plate mounts generally include a bracket attached to the rear of the vehicle having threaded bores for accepting mounting bolts that attach the license plate to the bracket. A light is usually included for illuminating the license plate when the lights of the vehicle are illuminated.

Some vehicles are provided with drop-gates. A drop-gate is a tailgate that is hinged so as to rotatably lower from an upright position to a prone position. For example, drop-gates are commonly a feature of station wagons, sport utility vehicles, pick-up trucks, commercial trucks and trailers. Generally, because the vehicle may be operated with the drop-gate in the prone position, it is customary to locate the license plate mount at a component that does not rotate with the drop-gate, such as for example the rear bumper. It would be desirable for vehicles equipped with drop-gates to have the license plate mount located as a feature on the drop-gate. However, to accommodate such a structural configuration, the problem of the license plate disappearing from view of onlookers when the drop-gate is in the prone position must first be overcome.

Accordingly what remains needed in the art is a license plate mount that provides visibility of the license plate to onlookers at all times whether the drop-gate is at, or anywhere between, the upright and prone positions.

### SUMMARY OF THE INVENTION

The present invention is an articulated license plate mount for locating a license plate at the drop-gate of a vehicle, wherein the license plate will be visible to onlookers at all times whether the drop-gate be at, or between, its upright and prone positions.

The articulated license plate mount according to the present invention includes a gate bracket which is connected to a drop-gate, a license bracket to which is connected a license plate via an attachment feature, and a pivot connection which pivotally connects the license bracket to the gate bracket. The pivot connection is located adjacent a top end of the license bracket. With the drop-gate in the upright position, the license plate and license bracket are oriented vertically (parallel with the gate bracket and generally parallel with the exterior skin of the drop-gate) by action of gravity due to their low center of gravity that is well below the pivot connection. As the drop-gate is rotatably lowered to the prone position, the license bracket pivots via the pivot connection so as to maintain the license bracket and license plate in the upright position, by action of gravity due to a center of gravity well below the pivot connection. When the drop-gate achieves the prone position, the license bracket and license plate are still in the vertical orientation such that the license plate is clearly visible to onlookers (perpendicular with the gate bracket and generally perpendicular with the exterior skin of the drop-gate. Now, as the drop-gate is rotatably raised back to the upright position, the license bracket again pivots on the pivot connection, as discussed above by action of gravity, such that when the drop-gate is at the upright position the license bracket remains vertically oriented (now again generally parallel to the exterior skin of the drop-gate).

While a free pivot regulated by gravity at the pivot connection between the gate and license brackets works well, cams may be provided so that the relative position of the license bracket relative to the gate bracket is manually selectable. Cams serve to hold the license bracket in a fixed position and thereby reduce sway.

Accordingly it is an object of the present invention to provide an articulated license plate mount for a license plate for mounting to a drop-gate such that the articulated license plate mount retains the license plate visible to onlookers at any rotational position of the drop-gate.

This and additional objects, features and advantages of the present invention will become clearer from the following specification of a preferred embodiment.

### BRIEF DESCRIPTION OF THE DRAWINGS

FIG. 1 is a rear plan view of a vehicle having a drop-gate equipped with an articulated license plate mount according to the present invention, wherein the drop-gate is at the upright position.

FIG. 2 is a partly cut-away, rear side view of the vehicle of FIG. 1, wherein the drop-gate is at the prone position.

FIG. 3 is an expanded, perspective view of the articulated license plate mount according to the present invention, shown with respect to a drop-gate.

FIG. 4 is a rear view of the articulated license plate mount according to the present invention.

FIG. 5 is a partly perspective view, seen along line 5-5 in FIG. 4.

FIG. 6 is a partly sectional side view of a drop-gate equipped with an articulated license plate mount according to the present invention, wherein the drop-gate is at the upright position.

FIG. 6A is a partly sectional detail view of the articulated license plate mount as seen at circle 6A of FIG. 6.

FIG. 7 is a is a partly sectional side view of a drop-gate equipped with an articulated license plate mount according to the present invention, wherein the drop-gate is at the prone position.

FIG. 7A is a partly sectional detail view of the articulated license plate mount as seen at circle 7A of FIG. 7.

FIG. 8A is a partly sectional detail view of the articulated license plate mount similar to FIG. 6A, wherein a first cam retains the orientation of the license bracket parallel relative to the gate bracket.

FIG. 8B is a partly sectional detail view of the articulated license plate mount similar to FIG. 7A, wherein a second cam retains the orientation of the license bracket perpendicular relative to the gate bracket.

### DESCRIPTION OF THE PREFERRED EMBODIMENT

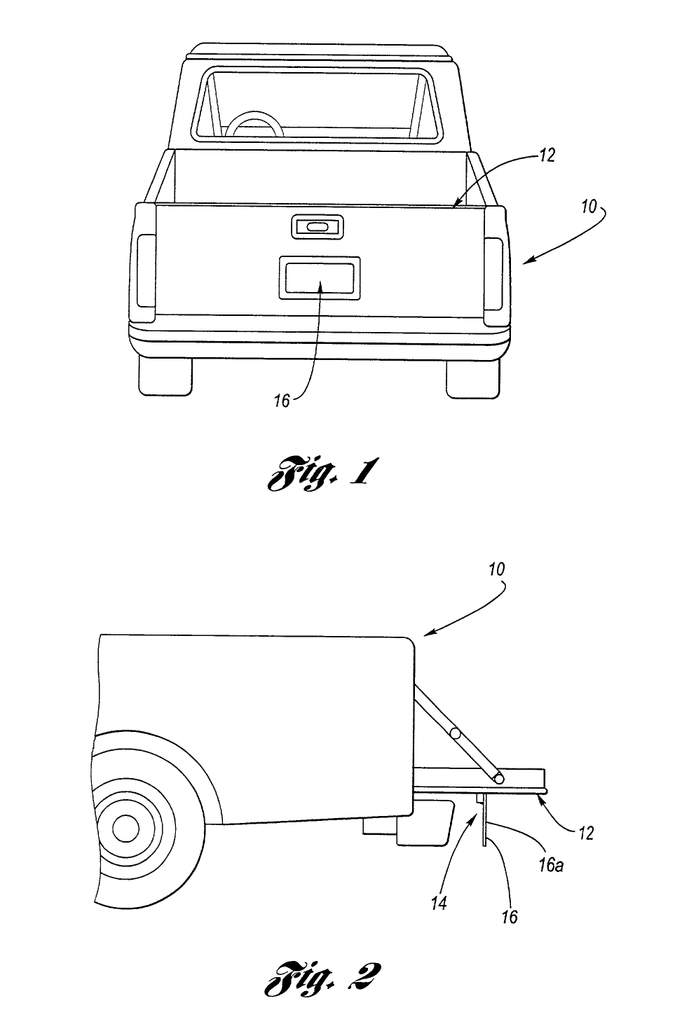

FIGS. 1 and 2 depict a vehicle 10 (by way of example only, a pick-up truck) wherein the drop-gate 12 thereof is equipped with an articulated license plate mount 14 according to the present invention. At FIG. 1, the drop-gate 12 is at its upright position, and a license plate 16, which is connected with the articulated license plate mount 14, is oriented vertically and generally parallel with the exterior skin of the drop-gate such as to be clearly visible to onlookers. At FIG. 2, the drop-gate 12 is at its prone position, and the license plate 16 remains oriented vertically and generally perpendicular with the exterior skin of the drop-gate and further remains clearly visible to onlookers. As can therefore be recognized by a comparison between FIGS. 1 and 2, the articulated license plate mount 14 provides for a pivoting of the license plate so as to keep it vertical and at all times visible to onlookers no matter the position of the drop-gate.

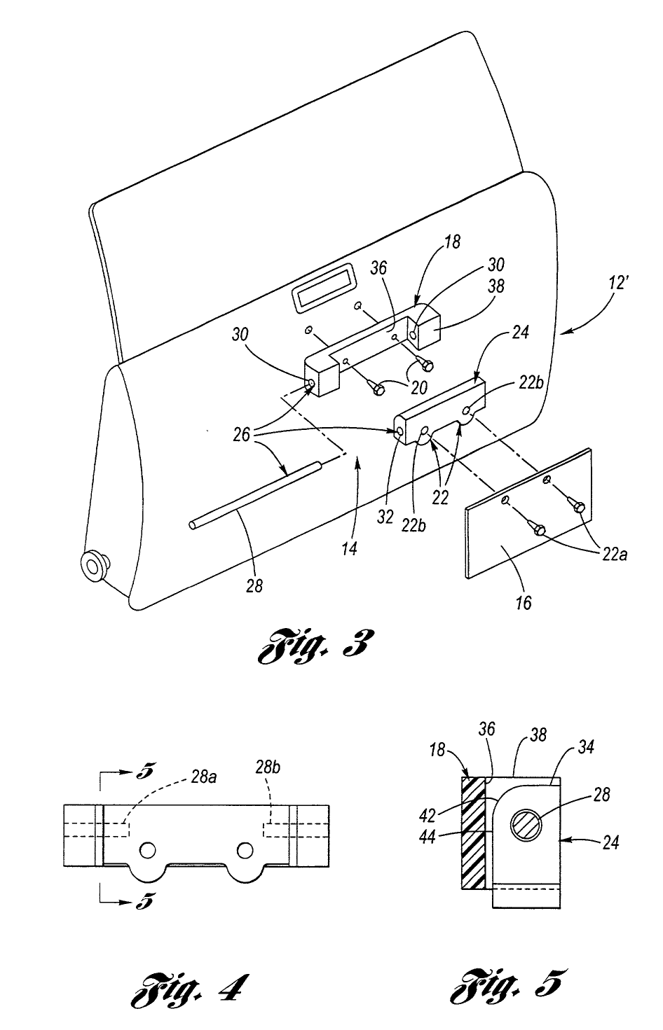

FIG. 3 is an exemplification of a preferred structure for the articulated license plate mount 14. A gate bracket 18 is attached by screws 20 (as for example sheet metal screws) to a drop-gate 12′ (shown, by way of example only, as a station wagon drop-gate). A license plate 16 is attached to a license bracket 24. The license bracket 24 is pivotally connected to the gate bracket 18 via a pivot connection 26. The pivot connection 26 may take any suitable form. For example, a pivot rod 28 passing through bracket holes 30, 32 in the gate and license brackets, respectively; or for further example, a pair of pivot rods 28a, 28b passing through respective bracket holes, as shown at FIG. 4. The pivot connection 26 is located adjacent a top end 34 of the license bracket 24 so as to be well above the center of gravity of the collective mass of the license plate 16 and license bracket 24. The preferred material for the gate and license brackets 18, 24 is a UV resistant plastic material.

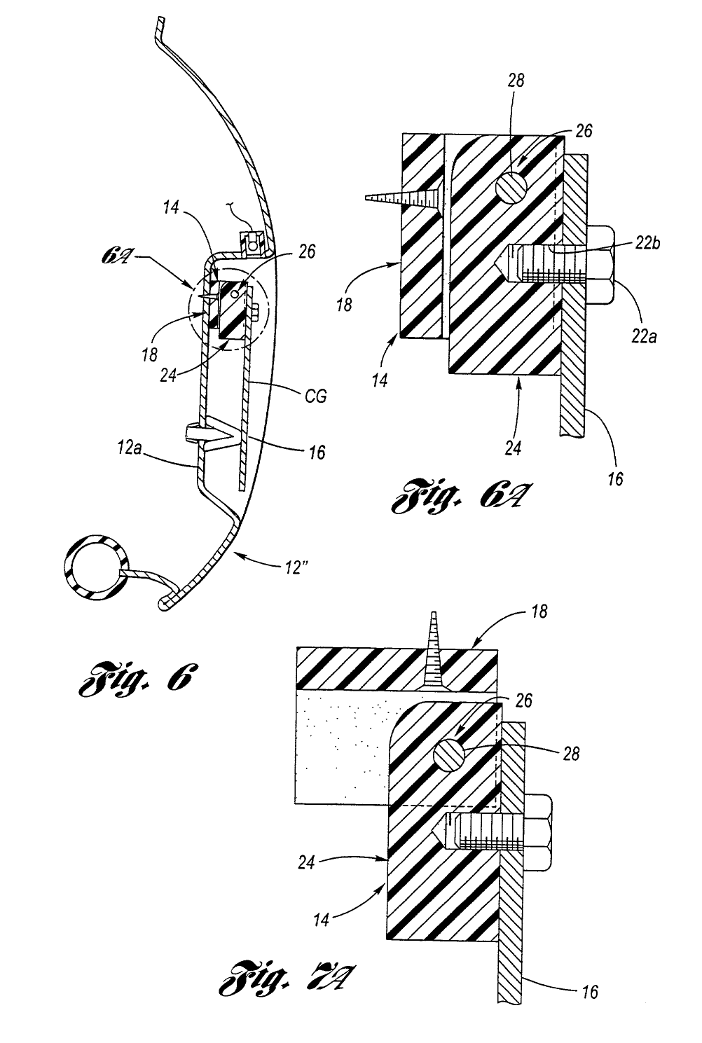

The gate bracket 18 is preferably of a U-shape, having a back wall 36 and integral end walls 38, wherein the gate bracket is attached to the drop-gate 12 via the back wall and the bracket holes 30 are located at the end walls. The license bracket 24 is preferably of an elongated block-shape, wherein the bracket holes 32 are provided at each end thereof (see FIG. 4), and may extend all the way therethrough (per FIG. 3). A clearance is provided between an inboard surface 44 of the license bracket 24 and the back wall 36 of the gate bracket 18 as shown in FIG. 5. The intersection 42 of the top end 34 and inboard surface 44 of the license bracket 24 is rounded so that the license bracket is able to pivot at close clearance relative to the gate bracket 18.

The license plate 16 is attached to the license bracket 24 via the attachment feature 22, which preferably has the form of mounting bolts 22a (preferably of the conventional type for mounting license plates, as mentioned hereinabove) threading into threaded bores 22b of the license bracket. The attachment feature 22 is located adjacent the top end 34 of the license bracket 24 so as to hold the license plate 16 at its two upper holes, but may also optionally include holding the license plate at its two lower holes not shown.

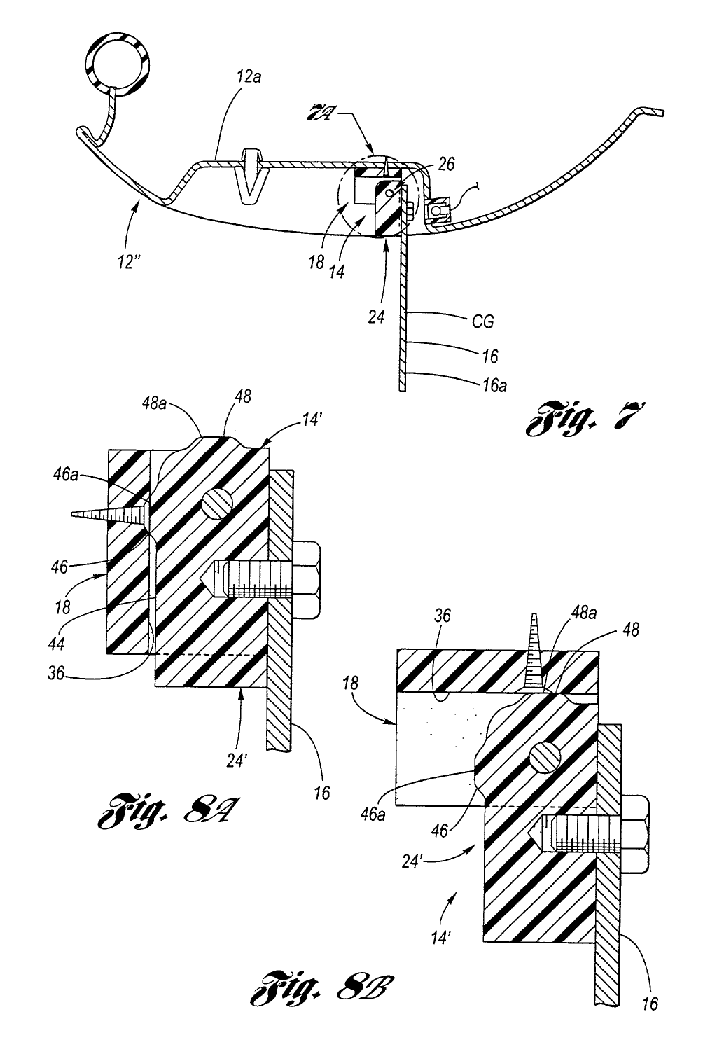

Turning attention now additionally to FIGS. 6 through 7A, operation of the articulated license plate will be detailed.

FIG. 6 depicts a drop gate 12″ (by way of example only, being that of a sport utility vehicle), in the upright position, wherein the license bracket 24 and the attached license plate 16 are in a vertical orientation as shown also at FIG. 6A. The license plate 16, which is generally parallel with the skin 12a of the drop-gate 12″, is easily visible to onlookers. The license bracket 24 and the license plate 16 have a combined center of gravity CG which is located remotely vertically below the pivot connection 26 (see FIG. 6). Accordingly, the license bracket 24 and license plate 16 are kept in the vertical orientation by gravity, which tends to vertically align the center of gravity CG and the pivot connection 26.

FIG. 7 depicts the drop gate 12″ now rotated downwardly from the upright position of FIG. 6 to the prone position, wherein the license bracket 24 and the attached license plate 16 remain in the vertical orientation as shown also at FIG. 7A. The license plate 16, which is now generally perpendicular with the skin 12a of the drop-gate 12, remains easily visible to onlookers. As mentioned, the license bracket 24 and the license plate 16 have a combined center of gravity CG which is located remotely vertically below the pivot connection 26. Accordingly, the license bracket 24 and license plate 16 are kept in the vertical orientation by gravity, which tends to vertically align the center of gravity CG and the pivot connection 26 even as the drop-gate is rotated from the upright to the prone positions, and from the prone position back to the upright position.

As a result of the articulated license plate mount 14, a vehicle equipped with a drop-gate having a license plate mounted thereto may be operated with the drop-gate in the prone position, yet the license plate (that is, the front face 16a thereof) will be clearly visible to onlookers, as depicted by way of example at FIGS. 2 and 7.

FIGS. 8A and 8B depict a variation of the articulated license plate mount 14′, wherein cams 46 and 48 are provided so that the relative position of the license bracket relative to the gate bracket is manually selectable, and not simply gravity regulated. The cams may be located on either or both the license and gate brackets. By way of example, FIG. 8A depicts a first cam 46 located at the inboard surface 44 of the license bracket 24′. The first cam 46 has a flat 46a which pinchably abuts the back wall 36 of the gate bracket 18. The flat 46a serves as a cam surface which tends to hold the license bracket 24′ in the vertical orientation when the drop-gate is in the upright position (as shown at FIGS. 1, 6 and 8A). The second cam 48 has a flat 48a, which also pinchably abuts the back wall 36 of the gate bracket 18. This flat 48a also serves as a cam surface, which now tends to hold the license bracket 24 in the vertical orientation when the drop-gate is in the prone position (as shown at FIGS. 2, 7 and 8B). The first and second cams serve to hold the license bracket in a manually defined fixed position, and further serve to reduce or eliminate license plate sway particularly when the drop-gate is in the prone position.

To those skilled in the art to which this invention appertains, the above-described preferred embodiment may be subject to change or modification. Such change or modification can be carried out without departing from the scope of the invention, which is intended to be limited only by the scope of the appended claims.

1. An articulated license plate mount for a drop-gate, comprising:
a license bracket having a license plate attachment feature;
a gate bracket;
a pivot connection pivotally connecting said license bracket to said gate bracket; and
at least one cam located on at least one of said gate and license brackets for holding said license bracket in at least one selected orientation relative to said gate bracket.

2. The articulated license plate mount of claim 1, wherein said cam comprises:
a first cam surface for retaining said license bracket in an orientation generally parallel with respect to said gate bracket; and
a second cam surface for retaining said license bracket in an orientation generally perpendicular with respect to said gate bracket.

3. A drop-gate having a license plate mount comprising:
a drop-gate rotatable between an upright position and a prone position; and
an articulated license plate mount connected to said drop-gate, said articulated license plate mount comprising a license bracket pivotally movable with respect to said drop-gate, said license bracket having a top end and a license plate attachment feature.

4. The drop-gate of claim 3, wherein said license plate mount further comprises:
a gate bracket fixedly connected to said drop-gate; and
a pivot connection pivotally connecting said license bracket to said gate bracket;
wherein said pivot connection is located adjacent said top end.

5. The drop gate of claim 4, further comprising a license plate connected to said license bracket, wherein said license bracket and said license plate have a collective center of gravity located remote with respect to said pivot connection, and wherein said center of gravity is generally kept by gravity in substantially vertical alignment with said pivot connection as said drop gate is rotated between said upright and prone positions.

6. The drop gate of claim 4, further comprising at least one cam located on at least one of said gate and license brackets for holding said license bracket in at least one selected orientation relative to said gate bracket.

7. The drop gate of claim 6, wherein said at least one cam comprises:
a first cam for retaining said license bracket in a vertical orientation when said drop-gate is at said upright position; and
a second cam for retaining said license bracket in a vertical orientation when said drop-gate is at said prone position.

8. In a license plate mounted to a drop-gate, a method for keeping the license plate always visible to onlookers irrespective of the rotational position of the drop-gate, said method comprising the steps of:
attaching an articulated license plate mount to the drop-gate;
attaching a license plate to the articulated license plate mount; and
pivoting the license plate at the articulated license plate mount as the drop-gate is rotated so as to retain the license plate in a vertical orientation.

9. The method of claim 8, wherein said step of pivoting is caused by gravity.
